(19) United States
(12) Patent Application Publication
(10) Pub. No.: US 2010/0230189 A1
(43) Pub. Date: Sep. 16, 2010

(54) COOLING SYSTEM FOR A VEHICLE

(75) Inventor: Daniel D. Cottrell, V, Commerce Township, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERRATIONS, INC., Detroit, MI (US)

(21) Appl. No.: 12/403,603

(22) Filed: Mar. 13, 2009

(51) Int. Cl. B60K 11/02; F01P 1/06

(52) U.S. Cl. 180/65.21; 123/41.31; 903/904

(57) ABSTRACT

A cooling system is provided for a vehicle having an electric power producing device and a power-plant operable to propel the vehicle. The cooling system includes a primary heat exchanger arranged relative to the power-plant. The primary heat exchanger is operable to receive coolant from the power-plant, reduce temperature of said coolant, and return the reduced temperature coolant to the power-plant. The cooling system additionally includes an auxiliary heat exchanger arranged relative to the primary heat exchanger, and operable to receive the reduced temperature coolant from the primary heat exchanger. The auxiliary pump further reduces the temperature of said coolant, and provides the further reduced temperature coolant to the electric power producing device. The electric power producing device may be employed in a hybrid vehicle, where the electric power producing device is a motor-generator operable to propel the vehicle.

### TECHNICAL FIELD

The present invention relates to a cooling system for a vehicle and a method of controlling such a cooling system.

### BACKGROUND OF THE INVENTION

Modern vehicles employ various electric power producing devices configured to satisfy a range of objectives. One example of such a device is an electric motor-generator employed in conjunction with a power-plant, such as an internal combustion engine, as part of a hybrid propulsion system. Another example of such a device is a power electronics module.

As a by-product of generating power for propelling the vehicle, the power-plant produces heat energy. To ensure efficient and reliable performance of the power-plant, such heat energy is typically removed via a coolant. Likewise, as a consequence of generating electrical power, the aforementioned electric devices also generate heat, which similarly must be removed.

### SUMMARY OF THE INVENTION

In view of the foregoing, a cooling system for a vehicle having an electric power producing device and a power-plant operable to propel the vehicle is provided. The cooling system includes a primary heat exchanger arranged relative to the power-plant. The primary heat exchanger is operable to receive coolant from the power-plant, reduce temperature of the coolant, and return the reduced temperature coolant to the power-plant. The cooling system also includes an auxiliary heat exchanger arranged relative to the primary heat exchanger, operable to receive the reduced temperature coolant from the primary heat exchanger. The auxiliary heat exchanger is arranged to further reduce the temperature of the coolant, and provide the further reduced temperature coolant to cool the electric power producing device. The electric power producing device may be employed in a hybrid vehicle, where the electric power producing device is a motor-generator operable to propel the vehicle.

The auxiliary heat exchanger is further arranged to reduce the temperature of the coolant and provide the further reduced temperature coolant to the electric power producing device. The cooling system may have the reduced temperature coolant returned to the power-plant at a predetermined flow rate, and provide the further reduced temperature coolant to the electric power producing device at a flow rate lower than the predetermined flow rate.

The cooling system may further include a primary pump operable to return the reduced temperature coolant to the power-plant. The cooling system may additionally include an auxiliary pump controlled by an electronic controller to supply the further reduced temperature coolant from the auxiliary heat exchanger to the electric power producing device. In the alternative, the cooling system may include an orifice configured to control flow of the further reduced temperature coolant from the auxiliary heat exchanger to the electric power producing device. In either case, the flow rate of the further reduced temperature coolant to the electric power producing device may be controlled to approximately 0.5 to 2 liters/minute.

In an alternate embodiment, a method of controlling a cooling system for a hybrid vehicle having a power-plant and a motor-generator operable to propel the vehicle is provided. The method includes receiving coolant of a first temperature from the power-plant via a primary heat exchanger arranged relative to the power-plant. The method additionally includes reducing the temperature of the coolant via the primary heat exchanger, and returning a first portion of the reduced temperature coolant to the power-plant. The method also includes delivering a second portion of the reduced temperature coolant from the primary heat exchanger to an auxiliary heat exchanger arranged relative to the motor-generator. The method additionally includes further reducing temperature of the second portion of coolant via the auxiliary heat exchanger, and controlling delivery of the further reduced temperature second portion of the coolant to the motor-generator. The method further includes delivering the second portion of coolant from the motor-generator to the power-plant.

The returning of the reduced temperature coolant to the power-plant may be accomplished at a predetermined flow rate, and the providing of the further reduced temperature coolant to the motor-generator may be accomplished at a flow rate lower than the predetermined flow rate. The controlling the flow rate of the further reduced temperature coolant may be performed by a controller.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagrammatic view of a first embodiment of a vehicle cooling system;

FIG. 2 is a schematic diagrammatic view of a second embodiment of a vehicle cooling system;

FIG. 3 illustrates a plot of operating temperatures versus coolant flow rate for a motor-generator cooled by the cooling system shown in FIGS. 1 and 2; and

FIG. 4 schematically illustrates, in flow chart format, a method in accordance with the embodiment for controlling the cooling system shown in FIG. 1.

### DESCRIPTION OF THE PREFERRED EMBODIMENTS

The cooling system according to the preferred embodiment includes an electric power producing device employed in a vehicle and cooled by a heat transfer fluid, i.e. coolant, also utilized to cool a power-plant, such as an internal combustion (IC) engine or a fuel cell. The contemplated coolant is typically is a solution of a suitable organic chemical (most often ethylene glycol, diethylene glycol, or propylene glycol) in water. The fluid cooled electric power producing device may be a power electronics module, or a motor-generator employed as part of a hybrid propulsion system to drive such a vehicle, as understood by those skilled in the art.

Hybrid propulsion systems have been developed in an effort to improve vehicle fuel efficiency and reduce vehicle exhaust emissions. Generally, by shutting off the vehicle's power-plant when it would otherwise be operating at idle or idle stop, and enabling early fuel cut-off during vehicle deceleration, improved vehicle fuel economy can be achieved. Typically, such hybrid propulsion systems utilize a motor-generator in addition to the power-plant to drive the vehicle.

In some hybrid propulsion systems a power-plant, such as above, is the primary source of vehicle power. In such systems, a motor-generator is typically employed as a Belt Alternator Starter (BAS). The BAS is typically used for generating electrical energy for use by vehicle accessories, and for quickly restarting and spinning the power-plant up to operating speeds. In other types of hybrid propulsion systems, a motor-generator is employed to assist the power-plant in powering, i.e. driving, the vehicle, and, in certain conditions, even functioning as a sole source of vehicle power.

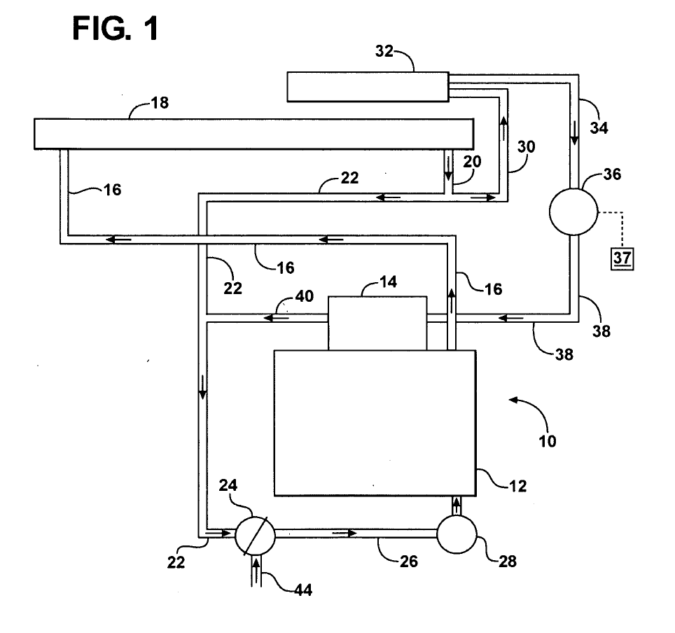

Referring now to the drawings in which like elements are identified with identical minerals throughout, FIG. 1 shows a hybrid vehicle cooling system 10. The cooling system 10 includes a power-plant 12, and a motor-generator 14 operatively connected to the power-plant. The power-plant 12 may be an internal combustion (IC) engine, such as a spark ignition or a compression ignition engine, or a fuel cell. Although a motor-generator is described within the cooling system 10, a combined alternator-starter, a power electronics module, or any other electronic device for producing electrical power, and having a provision for circulation of coolant is similarly envisioned.

The power-plant 12 may be used to propel the vehicle, while the motor-generator 14, in this case a motor-generator, may be used to provide rapid restart of the power-plant 12 from shut down mode, i.e. stop or idle stop operation. The motor-generator 14 may also be employed to generate power for propelling the hybrid vehicle while the power-plant 12 is shut down. As understood by those skilled in the art, there may be a number of ways to interconnect the power-plant 12 with the motor-generator 14 to provide these functions.

The power-plant 12 produces heat energy as a by-product of generating power used to propel the hybrid vehicle. Such heat energy is removed via a coolant, i.e. circulating cooling fluid (not shown), continuously cycling through multiple conduits of the cooling system 10. The coolant exits the power-plant 12 and is delivered to a primary heat exchanger 18 via a conduit 16. The heat exchanger 18 is contemplated as a water-to-air radiator configured to ensure sufficient reduction of coolant temperature in order to ensure efficient performance of the power-plant 12. After the coolant temperature has been reduced inside the heat exchanger 18, the coolant exits the heat exchanger via conduit 20.

The conduit 20 splits into two conduit branches, a conduit 22 configured to deliver the reduced temperature coolant to a thermostat 24, which is configured to control flow rate of coolant, and a conduit 30. Thermostat 24 receives from conduit 44 a portion of the coolant returning from a heating and ventilation system (not shown) of the vehicle. Past the thermostat 24, the reduced temperature coolant delivered by the conduit 22 proceeds via conduit 26 to a primary fluid pump 28. The reduced temperature coolant is thereby returned to the power-plant 12, completing the coolant circulation. The baseline volume and pressure of the coolant in the conduits 16, 20, 22 and 26 are provided via the primary fluid pump 28, while the thermostat 24 restricts coolant flow to a predetermined flow rate for circulating through the power-plant 12.

The conduit 30 diverts some of the reduced temperature coolant after the heat exchanger 18, and delivers that portion of the coolant to an auxiliary heat exchanger 32 for further temperature reduction. The auxiliary heat exchanger 32 is configured to process coolant at a relatively low flow rate in the range of 0.5-2 liters/minute, thus providing more time to further reduce temperature of the coolant. Operational target of the auxiliary heat exchanger 32 at 30 degrees Celsius ambient temperature is in the range of 40-60 degrees Celsius coolant discharge temperature. Precise target for the operational temperature of the auxiliary heat exchanger 32 would be determined based on the temperature of incoming coolant from the primary heat exchanger 18 and the heat rejection capacity of the auxiliary heat exchanger 32. After coolant temperature is further reduced inside the auxiliary heat exchanger 32, the coolant is discharged to conduit 34.

The conduit 34 delivers the further reduced temperature coolant to auxiliary fluid pump 36. The fluid pump 36 pressurizes the further reduced temperature coolant and delivers the coolant to the motor-generator 14, for removing heat energy produced by the motor-generator during power generation. The fluid pump 36 is controlled by a controller 37 to provide coolant at the aforementioned 0.5-2 liters/minute flow rate. After heat energy of the motor-generator 14 has been removed, the coolant exits the motor-generator via conduit 40, and is delivered to conduit 22 where it rejoins the reduced temperature coolant delivered by the primary heat exchanger 18 to the thermostat 24. After the thermostat 24, the fluid is delivered to the conduit 26, and, through the pump 28, back to the power-plant 12.

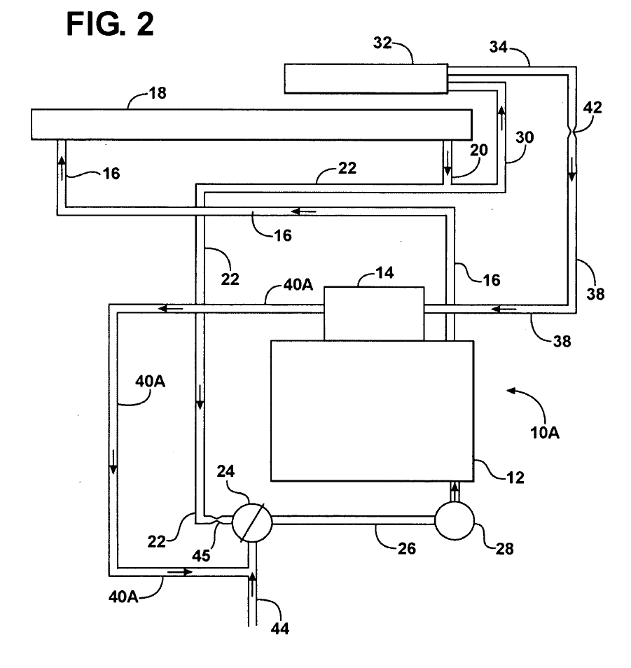

FIG. 2 shows an alternative hybrid vehicle cooling system 10A where all like elements are numbered identically as those appearing in FIG. 1. The cooling system 10A is configured identically from the power-plant 12 up through the auxiliary heat exchanger 32. The further reduced temperature coolant is discharged from the auxiliary heat exchanger 32 to the conduit 34, which delivers the coolant to an orifice 42. The orifice 42 is configured to restrict the flow of the further reduced coolant to the motor-generator 14 down to the motor-generator coolant flow requirement of 0.5-2 liters/minute.

As a consequence of the orifice 42 restricting coolant flow, the coolant remains inside the auxiliary heat exchanger 32 for a longer period of time, thereby permitting a larger coolant temperature drop. The further reduced temperature coolant is delivered to the motor-generator 14 via the conduit 38. After heat energy of the motor-generator 14 has been removed, the coolant exits the motor-generator via conduit 40A, and is delivered to the conduit 44 upstream of the thermostat 24 (shown in FIG. 2). Orifice 45 is positioned just upstream of the thermostat 24 in conduit 22, and configured to establish a coolant pressure drop required to create coolant flow in coolant system 10A. Alternately, the orifice 45 may be incorporated into the physical structure of the thermostat 24 to accomplish the same result. After the coolant passes through the thermostat 24, it is delivered to the conduit 26, and, through the pump 28, back to the power-plant 12.

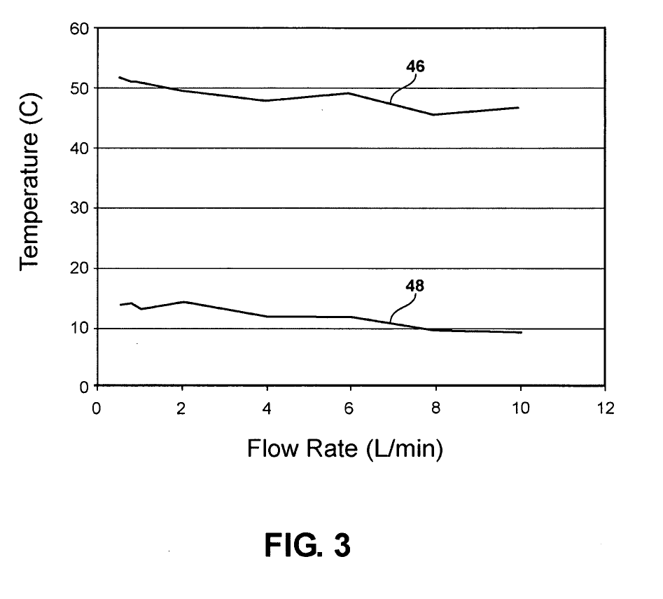

FIG. 3 illustrates a plot of experimentally determined operating temperatures of the motor-generator 14 versus coolant flow rate. Although not shown, characteristically, the motor-generator 14 follows typical construction of an electric motor. As such, a motor-generator generally employs a steel stator with wire windings, wherein the stator has its outer portion pressed into an aluminum housing which includes a coolant jacket. Typically, during motor-generator operation, heat is generated in the wire windings. Excess amount of heat may, however, render the motor-generator inoperative. Hence, it is generally desirable to remove excess heat while the motor-generator is in operation.

Excess heat may be removed from a motor-generator by radiation to ambient air, or by forced cooling via conduction to a purposefully channeled and circulated coolant. In the case of the motor-generator 14, the heat is conducted from the windings to the steel stator. From the stator, the heat is conducted to the aluminum housing, and from there it is taken away by coolant circulated through dedicated cooling passages (not shown), but that are in fluid communication with passages 38 and 40 of FIG. 1, or with passages 38 and 40A of FIG. 2. For sensing actual temperature of the stator, the motor-generator 14 may also incorporate a thermal sensor (not shown) in contact with the wire windings.

As can be seen from FIG. 3, difference between temperature of the windings and temperature of the coolant, designated by a trend line 46, is only reduced from 52 to 47 degrees Celsius, when coolant flow rate is increased from 0.25 to 10 liters/minute. Hence, the magnitude of the stator temperature drop is relatively insensitive to coolant flow rate. When coolant flow rate is increased from 0.25 to 10 liters/minute, difference between temperature of the outer portion of the steel stator in contact with the housing and temperature of the coolant, designated by a trend line 48, is only reduced from 14 to 9 degrees Celsius. Hence, the magnitude of the temperature drop of the outer portion of the steel stator is similarly insensitive to coolant flow rate. Therefore, a relatively low coolant flow rate, in the range of 0.5-2 liters/minute, can be utilized to generate a larger temperature drop in the auxiliary heat exchanger 32, in order to provide effective cooling for the motor-generator 14.

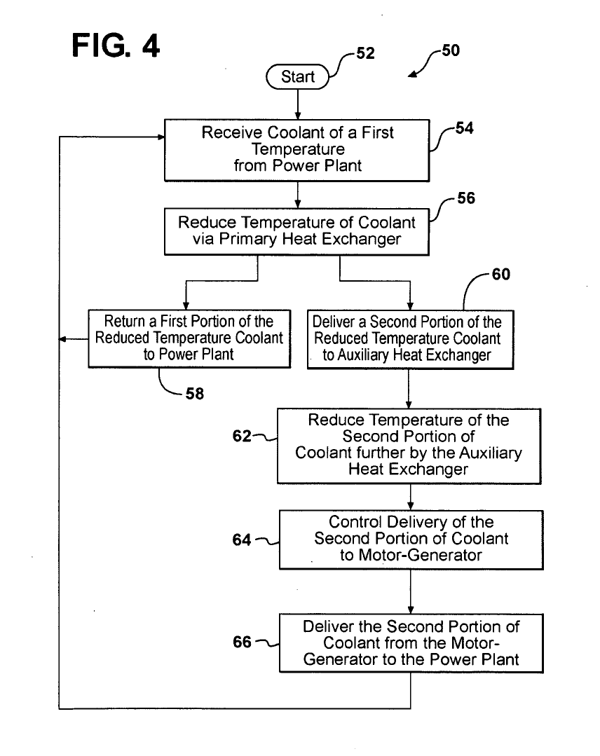

FIG. 4 depicts a method 50 of controlling the cooling system 10 or 10A shown in FIGS. 1 and 2, respectively. The method 50 is described with reference to FIGS. 1 and 2, and the above description of the coolant system 10. The method commences at block 52, and then proceeds to block 54. In block 54 increased temperature coolant is received from the power-plant 12. The method then advances to block 56. In block 56, temperature of the coolant is reduced by the primary heat exchanger 18. The method then returns a first portion of the reduced temperature coolant to the power-plant 12 in block 58, and delivers a second portion of the reduced temperature coolant to auxiliary heat exchanger 18 in block 60.

According to the method, following block 60, the temperature of the second portion of the reduced temperature coolant is then reduced further by the auxiliary heat exchanger 18 in block 62. The method then proceeds to block 64, where the delivery of the further reduced temperature second portion of coolant to the motor-generator 14 is controlled. Following block 64, the second portion of coolant is delivered from the motor-generator 14 to the power-plant 12. At this point the method 50 returns to block 52 and commences again. The method functions continuously according to the preceding description while the vehicle is in operation.

Although the method was described with respect to the motor-generator 14 employed in a hybrid vehicle propulsion system, the method may also be applied to cooling any electric power producing device having a provision for circulation of coolant.

While the best modes for carrying out the invention have been described in detail, those familiar with the art to which this invention relates will recognize various alternative designs and embodiments for practicing the invention within the scope of the appended claims.

1. A cooling system for a vehicle having an electric power producing device and a power-plant operable to propel the vehicle, the cooling system comprising:
a primary heat exchanger arranged relative to the power-plant, operable to receive coolant from the power-plant, reduce temperature of said coolant, and return the reduced temperature coolant to the power-plant; and
an auxiliary heat exchanger arranged relative to the primary heat exchanger, operable to receive the reduced temperature coolant from the primary heat exchanger, further reduce the temperature of said coolant, and provide the further reduced temperature coolant to cool the electric power producing device.

2. A cooling system of claim 1, wherein the vehicle is a hybrid, and the electric power producing device is a motor-generator operable to propel the vehicle.

3. The cooling system of claim 1, wherein the reduced temperature coolant is returned to the power-plant at a predetermined flow rate, and the further reduced temperature coolant is provided to said electric power producing device at a flow rate lower than the predetermined flow rate.

4. The cooling system of claim 3, further comprising a primary pump, wherein the reduced temperature coolant is returned to the power-plant via said primary pump.

5. The cooling system of claim 3, wherein the flow rate of the further reduced temperature coolant is controlled to approximately 0.5 to 2 liters/minute.

6. The cooling system of claim 1, further comprising an orifice in fluid communication with the auxiliary heat exchanger and with the electric power producing device, the orifice configured to control flow of the further reduced temperature coolant from the auxiliary heat exchanger to the motor-generator.

7. The cooling system of claim 1, further comprising an auxiliary pump operable to supply the further reduced temperature coolant from the auxiliary heat exchanger to the electric power producing device.

8. The cooling system of claim 7, further comprising a controller in electrical communication with the auxiliary pump, arranged to control said auxiliary pump.

9. A hybrid vehicle comprising:
a power-plant operable to propel the vehicle and shut down at idle;
a motor-generator mounted relative to the power-plant, operable to restart and spin the power-plant up to operating speeds;
a primary heat exchanger arranged relative to the power-plant, operable to receive coolant from the power-plant, reduce temperature of said coolant, and return the reduced temperature coolant to the power-plant; and
an auxiliary heat exchanger arranged relative to the motor-generator, and operable to receive the reduced temperature coolant from the primary heat exchanger, further reduce the temperature of said coolant, and provide the further reduced temperature coolant to said motor-generator.

10. The hybrid vehicle of claim 9, wherein the reduced temperature coolant is returned to the power-plant at a predetermined flow rate, and the further reduced temperature coolant is provided to said motor-generator at a flow rate lower than the predetermined flow rate.

11. The hybrid vehicle of claim 10, further comprising a primary pump, wherein the reduced temperature coolant is returned to the power-plant via said primary pump.

12. The hybrid vehicle of claim 11, wherein the flow rate of the further reduced temperature coolant is controlled to approximately 0.5 to 2 liters/minute.

13. The cooling system of claim 10, further comprising an orifice in fluid communication with the auxiliary heat exchanger and with the motor-generator, the orifice configured to control flow of the further reduced temperature coolant from the auxiliary heat exchanger to the motor-generator.

14. The cooling system of claim 10, further comprising an auxiliary pump operable to supply the further reduced temperature coolant from the auxiliary heat exchanger to the motor-generator.

15. The cooling system of claim 14, further comprising a controller in electrical communication with the auxiliary pump, arranged to control said auxiliary pump.

16. A method of controlling a cooling system for a hybrid vehicle having a power-plant and a motor-generator operable to propel the vehicle, the method comprising:
receiving coolant of a first temperature from the power-plant via a primary heat exchanger arranged relative to the power-plant;
reducing the temperature of the coolant via the primary heat exchanger;
returning a first portion of the reduced temperature coolant to the power-plant;
delivering a second portion of the reduced temperature coolant to an auxiliary heat exchanger arranged relative to the motor-generator;
reducing temperature of the second portion of coolant further via the auxiliary heat exchanger;
controlling delivery of the further reduced temperature second portion of the coolant to the motor-generator; and
delivering the second portion of coolant from the motor-generator to the power-plant.

17. The method of claim 16, wherein the returning of the first portion of the reduced temperature coolant to the power-plant is accomplished at a predetermined flow rate, and the controlling of the delivery of the further reduced temperature second portion of coolant to said motor-generator is accomplished at a flow rate lower than the predetermined flow rate.

18. The method of claim 17, wherein the controlling of the delivery of the further reduced temperature second portion of coolant is accomplished at approximately 0.5 to 2 liters/minute.

19. The method of claim 18, wherein the controlling of the flow rate of the further reduced temperature coolant is accomplished via a controller.
